(19) United States
(12) Patent Application Publication
(10) Pub. No.: US 2006/0141442 A1
(43) Pub. Date: Jun. 29, 2006

(54) Teacher's caddy

(76) Inventor: Mary Jackson Trufant, Harvey, LA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/317,569

(22) Filed: Dec. 23, 2005

Related U.S. Application Data
(60) Provisional application No. 60/639,236, filed on Dec. 23, 2004.

(51) Int. Cl. G09B 19/00

(52) U.S. Cl. 434/433

(57) ABSTRACT

A teachers caddy comprising a modular unit comprising upper and lower storage tiers, said upper tier being divided into a plurality of compartments; the lower section being divided into oppositely disposed compartments.

### CROSS-REFERENCE TO RELATED APPLICATIONS

This application claims benefit to provisional application 60/639,236, filed on Dec. 23, 2004, entitled “Teacher's Caddy,” which is incorporated by reference in its entirety.

### FIELD OF THE INVENTION

The present invention is directed to the field of organizational devices. In particular, the present invention is directed to a caddy to organize a teacher's work by classroom periods.

### BACKGROUND OF THE INVENTION

There have been a number of patents directed to the area of organizational devices for teachers. U.S. Pat. No. 6,364,362 discloses an educational planner for providing a cooperative system of planning books and folders that promote socially beneficial aims while providing assistance and organization of course materials.

U.S. Patent Publication No. 2003/0072605 discloses a planner tool comprising multiple pouch pages, lead cards, and printed calendar sheets. Each pouch page and calendar sheet has holes that are appropriately spaced apart so that each of the pages can be placed in a binder. The lead cards have two sets of times of the day and a blank center which are used in conjunction with the printed calendar sheets to make appointments to call, appointments to see others, and keep information regarding the nature of such appointments all in one place. The lead cards are placed in the pouches of the pages. The printed calendar sheets of the planner have the days of the week printed on them with specific columns under each day. The columns have the headings c, m, a, and e, which stand for call, mileage, appointment, and expenses respectively.

U.S. Patent Publication No. 2002/0106235 discloses a method and apparatus for assisting students and the like in organizing, and keeping organized, papers and materials for schoolwork and the like. Users will be able to place papers which will be needed at a future time, in a specific labeled, location for easy retrieval at a later time. The system motivates the initiation of work on a particular task, in a timely manner, because lost papers or materials are no longer an obstacle to beginning the task. This system and method comprises a short term, portable, sorting and filing system, a long term filing system and a linking device which encourages the user to consider specifically what to keep and what to discard. The system makes it obvious how and where to place items selected to keep. The system provides an organized group of places immediately available for things which need to be stored, short term and long term, for easy future retrieval. The system provides tools and training for time management. The system also encourages and instructs the user in building lifelong habits of being organized.

U.S. Pat. No. 5,864,869 discloses software utilizing a system and methodologies that allow cross-platform data transfer, either single user and/or networked access, for creating and maintaining an integrated classroom organizer using a computer. The user can create a year of detailed lesson plans. The user enters the number of pages of text(s), or quantified teaching block broken into percentage of completion, in a specified teaching period be it the entire year, semester, month, etc. The text(s) pages or percentage of a teaching task are allocated to designated teaching days previously identified in the calendar. The user can edit and determine whether the pre-scheduled number of text(s) pages, or percentage of a teaching task has been completed, by merely inputting the text(s) page or percentage completed. The difference between text(s) pages or percentage of task completed and the text(s) pages or percentage of task completion previously planned by user will match or not. If not, the software reallocates the difference and prompts user to adjust text(s) or teaching task progress. The software program is calendar driven and utilizes a relational database with calculations, scripts, and routines that allow the user to enter all elements required to create daily, weekly or monthly lesson plans; syllabi; seating charts; grades; attendance; progress reports; and student/parent letters. The software allows users to export and import software data to another computer. All data can be archived or copied to the next year for use and revision as deemed necessary by user.

U.S. Patent Publication No. 2001/0056365 discloses a method for marketing a school and office product system including the step of packaging a school and office product with a data storage device. The data storage device includes a program which enables the user to customize or personalize the school and office product. The method further includes the step of offering the packaged product and storage device for sale as a unit. The invention also includes a method for marketing a school and office product system including the step of packaging a school and office product with a data storage device. The data storage device includes a program which can aid a user in completing school projects. The method further includes the step of offering the packaged product and storage device for sale as a unit.

It is an object of the present invention to provide a teacher's caddy and organization system which helps teachers organize subjects and classes.

It is a further object to provide a system in which a teacher can organize class and course material.

These and other objects of the present invention will become apparent from the detailed description which follows.

### SUMMARY OF THE INVENTION

In accordance with the present invention, a teachers organizational caddy comprising: a modular unit comprising upper and lower storage sections, said upper section being divided into a plurality of compartments; the lower section being divided into oppositely disposed compartments.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a frontal view of a modular storage system in accordance with the present invention;

FIG. 2 is a rear view of a modular storage system in accordance with the present invention;

FIG. 3 is a perspective view of the present invention according to an embodiment;

FIG. 4 is a perspective view of the present invention according to an embodiment;

FIG. 5 is a bottom view of the present invention according to an embodiment;

FIG. 6 is a top view of the present invention according to an embodiment; and

FIG. 7 is a side view of the present invention according to an embodiment.

### DETAILED DESCRIPTION OF THE INVENTION

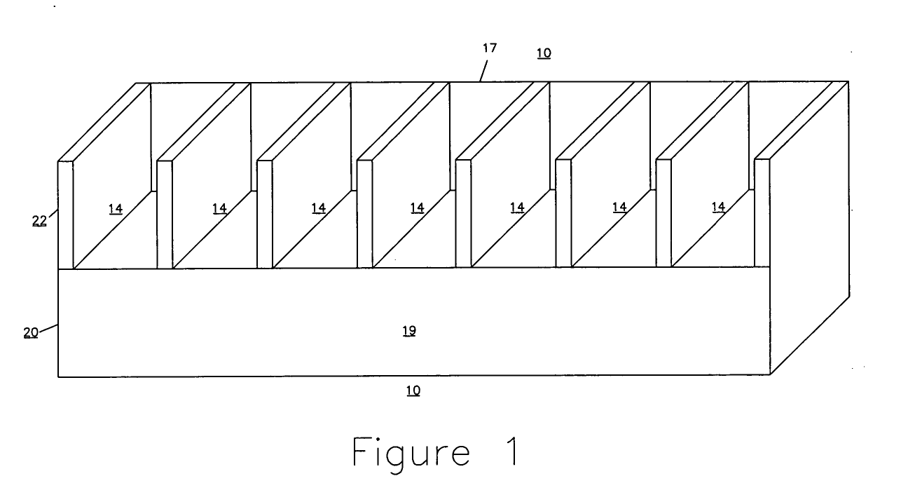

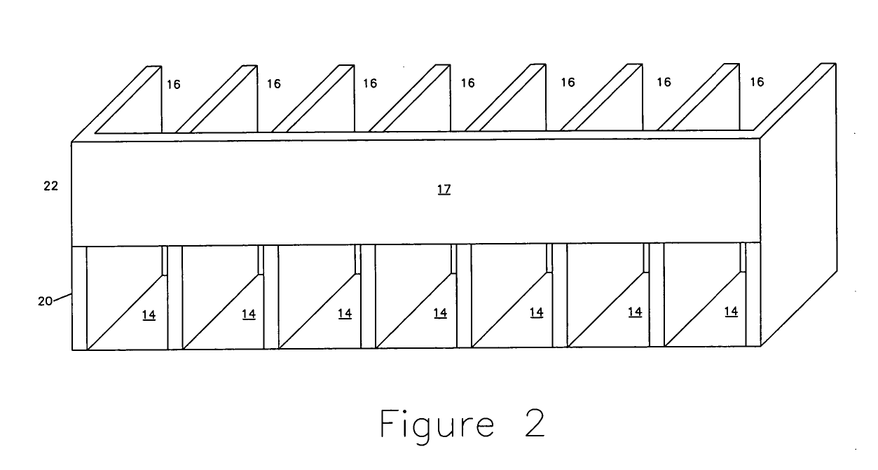

The present invention is described with reference to the enclosed Figures wherein the same numbers are utilized where applicable. In a first embodiment, shown in FIGS. 1 and 2, the invention is a modular system 10. The system has two vertical tiers 20, 22. The first tier 20 has a first row of compartment sections 12. The first row of compartments 14 is pointed on a first direction. The second tier 22 of compartments 16 points in an opposite direction to the first compartments. The tier rows of compartments have back walls 17, 19. The unit provides a plurality of storage areas.

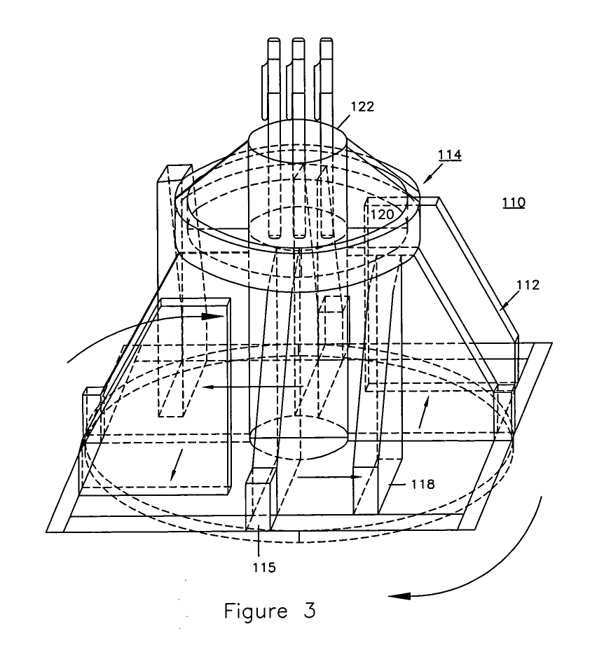

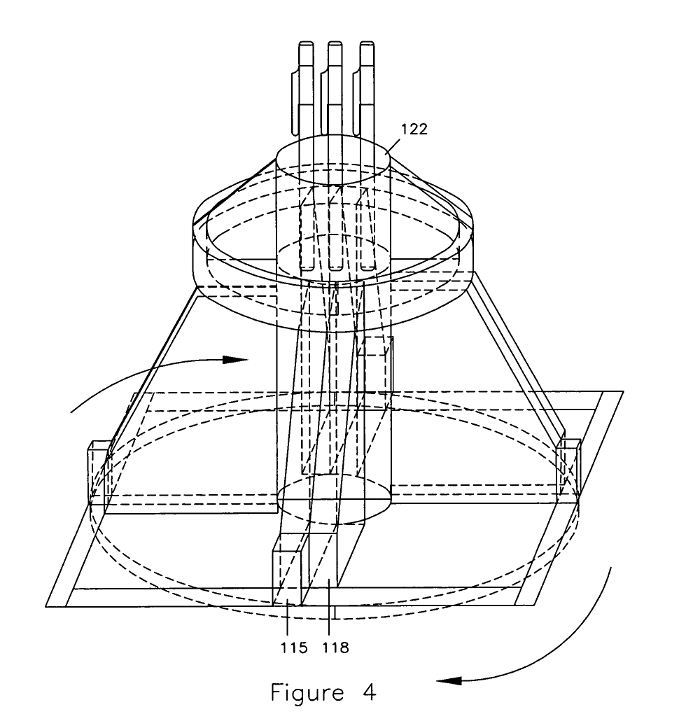

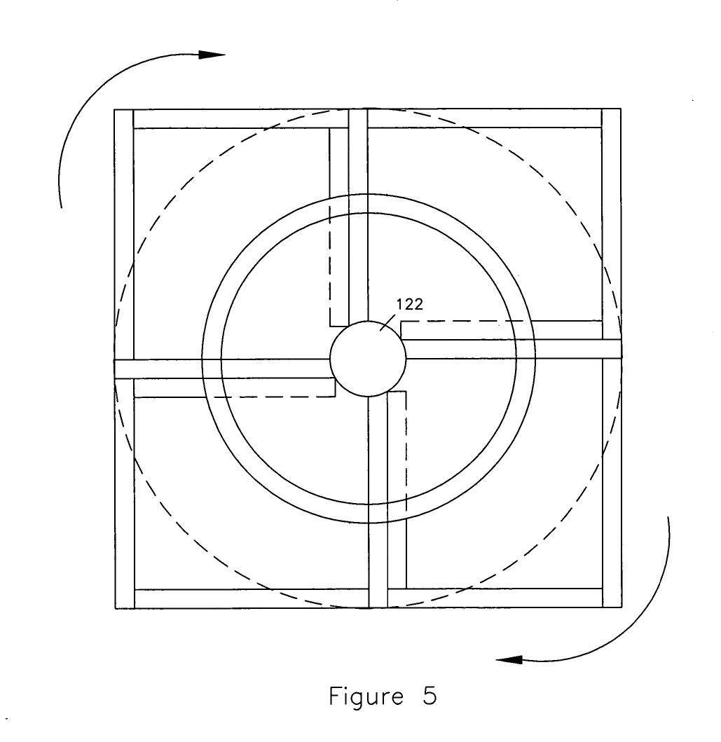

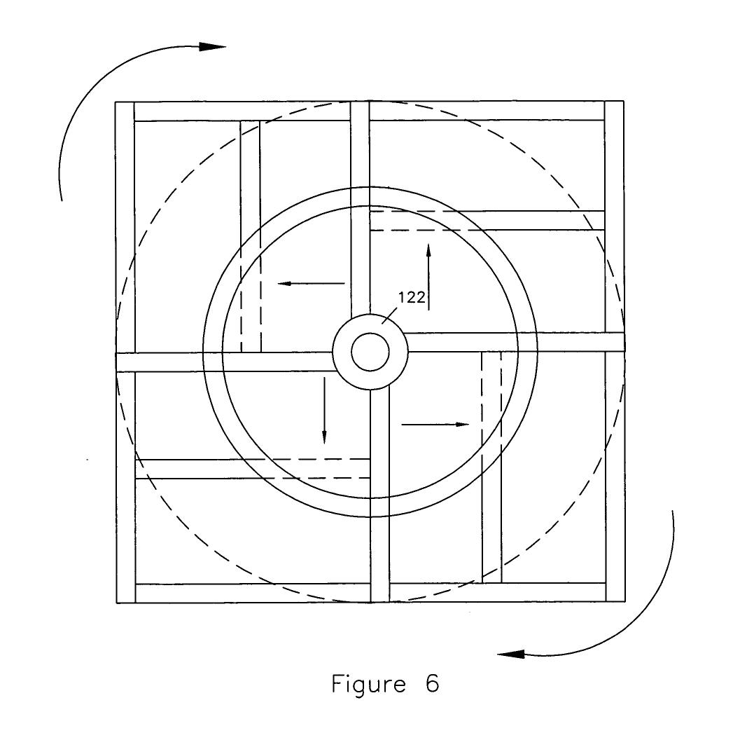

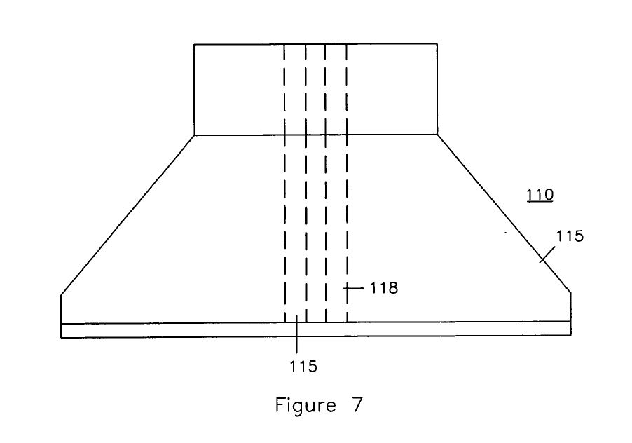

In a second embodiment, shown in FIGS. 3, 4, 5, 6 and 7, the invention is a rotatable caddy 114. The caddy 114 has a base 115 upon which the compartment sections 118 are mounted. The width of the compartment sections 118 is adjustable as shown in FIG. 3. These compartment sections 118 can be used to hold books, notebooks, folders and other class materials (not pictured). The top of the caddy 122 can be used as an additional storage area for containing smaller items such as pens, pencils, paper clips, etc. (not pictured)

The present invention has been described with reference to the above discussed preferred embodiment. The true nature and scope of the present invention is to be determined with reference to the attached claims.

1. Teachers caddy comprising:
a modular unit comprising upper and lower storage tiers, said upper tier being divided into a plurality of compartments;
the lower section being divided into oppositely disposed compartments.

2. A teachers caddy comprising:
A module comprising upper and lower storage sections, said upper section being divided into a plurality of fixed compartments;
the lower section oppositely disposed section, and being divided into compartments.
